(19) United States
(12) Patent Application Publication
(10) Pub. No.: US 2007/0022313 A1
(43) Pub. Date: Jan. 25, 2007

(54) Notifications in a telecommunications network

(75) Inventors: Michael Mackey, Dublin (IE); Martin Flynn, Dublin (IE); Peter Cautley, Wicklow (IE)

Correspondence Address: KIRSCHSTEIN, OTTINGER, ISRAEL;& SCHIFFMILLER, P.C., 489 FIFTH AVENUE, NEW YORK, NY, 10017, US

(73) Assignees: MARCONI INTELLECTUAL PROPERTY (RINGFENCE) INC., Warrendale, PA (US); Ericsson AB, Stockholm (SE)

(21) Appl. No.: 10/549,209

(22) PCT Filed: Mar. 15, 2004
(86) PCT No.: PCT/EP04/02837

§ 371 Date: Sep. 14, 2005

(30) Foreign Application Priority Data
Mar. 19, 2003 (GB) 0306237.9

(51) Int. Cl. G06F 11/00

(52) U.S. Cl. 714/4

(57) ABSTRACT

In a telecommunications network in which a threshold crossing alert (TCA) notification is generated when a threshold set for a variable related to an object of a network element (NE) of the network is crossed, there is provided a method of identifying the object, comprising: creating an entry for the variable in an alarm table of the NE, the entry comprising information concerning the identity of the NE and information concerning the position of the entry in the alarm table, constructing a managed object identity (MOID) of the object and storing this in the alarm table entry, using the alarm table entry to generate the TCA notification when the threshold is crossed, the TCA notification comprising the information concerning the identity of the NE and the information concerning the position of the entry in the alarm table, interrogating the TCA notification to read the information concerning the identity of the NE and the information concerning the position of the entry in the alarm table, accessing the alarm table entry using the information read from the TCA notification and identifying the object by reading the MOID of the object from the alarm table entry. The MOID of the object may be stored in a free format text alarm owner field of the alarm table entry.

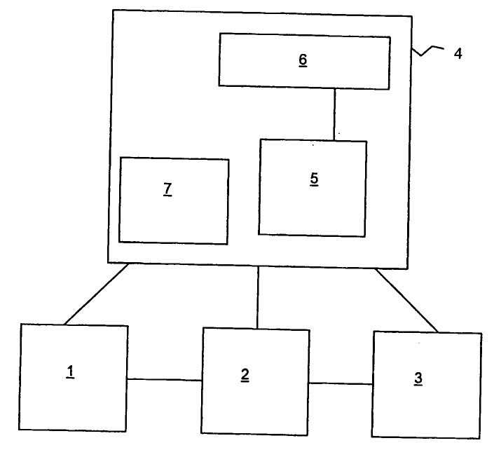

This invention relates to notifications in a telecommunications network, and a method of identifying an object of the network which has resulted in the generation of the notification.

Telecommunications networks are made up of many network elements (NEs), such as nodes, which comprise various components, for example boards, network modules, ports, links, connections, etc. The NEs and the components of NEs are often referred to as objects of the telecommunications network. A network management system (NMS) is generally used to manage the operation of the network. This performs many functions, including the management of some or all of the objects in the network. NEs send notifications to the NMS to inform the NMS of any changes in the status of the NE or a component of the NE, i.e. the NEs send notifications to the NMS to inform it of changes in the status of objects of the network.

Recent developments in telecommunications networks to comply with the Remote (network) Monitoring (RMON) Standard, RFC 2819, have resulted in the introduction of monitoring systems into NEs of telecommunications networks. Such systems allow monitoring of various variables related to a NE or a component of a NE, i.e. various variables relating to an object of the network. For example, switches which monitor their usage of internal central processing unit capacity, and connections which monitor their bandwidth usage, have been introduced into telecommunications networks. This new functionality further allows the setting of thresholds for one or more of the variables, and, if a threshold is crossed, a threshold crossing alert (TCA) and a TCA notification can be generated. However, such TCA notifications do not comprise identification of the object of the network to which the variable which has crossed the threshold relates. This can present problems when action has to be taken concerning the threshold crossing, as, for example, a manager of the network, on receiving details of the TCA, will not be able to identify the object of the network to which it relates.

According to a first aspect of the invention, in a telecommunications network in which a threshold crossing alert (TCA) notification is generated when a threshold set for a variable related to an object of a network element (NE) of the network is crossed, there is provided a method of identifying the object, comprising: creating an entry for the variable in an alarm table of the NE, the entry comprising information concerning the identity of the NE and information concerning the position of the entry in the alarm table, constructing a managed object identity (MOID) of the object and storing this in the alarm table entry, using the alarm table entry to generate the TCA notification when the threshold is crossed, the TCA notification comprising the information concerning the identity of the NE and the information concerning the position of the entry in the alarm table, interrogating the TCA notification to read the information concerning the identity of the NE and the information concerning the position of the entry in the alarm table, accessing the alarm table entry using the information read from the TCA notification, and identifying the object by reading the MOID of the object from the alarm table entry.

Identifying the object of the telecommunications network to which the variable which has crossed the threshold relates can therefore be achieved, and action can be taken concerning this, if necessary. Thus any TCA notification generated when a variable crosses a threshold can be matched to the object to which the variable relates, i.e. can be matched to the object which has resulted in the generation of the TCA notification. The telecommunications network may comprise many NEs, each of which has an alarm table. A TCA notification will be generated when a variable related to an object of a particular NE crosses a threshold. As the TCA notification comprises the identity of the NE and the identity of the entry for the variable in the alarm table of the NE, this allows the alarm table of the particular NE and the entry for the variable in the alarm table to be accessed, giving the MOID of the object to which the variable relates.

Creating the entry for the variable in the alarm table may be carried out in accordance with the RMON Standard RFC 2819. Creating the entry for the variable in the alarm table may be carried out by a network management system (NMS) of the telecommunications network. The alarm table entry may comprise information concerning the identity of the variable. The alarm table entry may comprise information concerning the threshold set for the variable. This may comprise a rising threshold value, for which a rising TCA notification is generated if the variable rises above the rising threshold value. Additionally or alternatively, this may comprise a falling threshold value, for which a falling TCA notification is generated if the variable falls below the falling threshold value. The rising threshold value may be greater than or equal to the falling threshold value. The alarm table entry may comprise information concerning one or more events, which are executed when the variable crosses the threshold. This may comprise a pointer to one or more entries for the variable in an event table of the NE, which detail the one or more events. The alarm table entry may comprise information concerning the identity of the entity (e.g. a network user or manager), which has created the alarm table entry. The alarm table entry may comprise information concerning how often the variable should be monitored. The alarm table entry may comprise information indicating that the value of the variable is to be monitored. The alarm table entry may comprise information indicating that changes in the value of the variable are to be monitored.

The method may comprise creating one or more entries for the variable in an event table of the NE. This may be carried out by a network management system (NMS) of the telecommunications network. The or each event table entry may comprise information concerning one or more events which are executed when the variable crosses the threshold. The one or more events include generation of a TCA notification, and may also include, for example, making an entry in a log table of the NE concerning the threshold crossing. The or each event table entry may comprise information concerning the identity of the entity (e.g. a network user or manager) which has created the event table entry.

Constructing the MOID of the object may comprise creating the MOID using a network management system (NMS) of the telecommunications network. This may comprise the NMS using information concerning the object and the variable held in the NMS. This may comprise storing the MOID in one or more tables of a database of the NMS. Constructing the MOID of the object may be carried out when the NMS discovers the NE which comprises the object. A MOID created by the NMS may be deterministic, i.e. if a NE is removed from the network, and subsequently reinserted into the network, a MOID created for an object of the NE when the NE is first inserted into the network will be the same as a MOID created for the object when the NE is reinserted into the network. The MOID of the object may be independent of the NMS used to create the MOID, i.e. a MOID of an object created by a first NMS of the network will be the same as a MOID for the object created by a second NMS of the network.

Storing the MOID of the object in the alarm table entry may comprise copying the MOID from a table of a database of a NMS of the network used to create the MOID. The MOID of the object may be stored in an alarm owner field of the alarm table entry. The alarm owner field may comprise a free format text field, which allows data to be added to existing data in the field. The alarm owner field may normally comprise information concerning the identity of the entity (e.g. a network user or manager), which has created the alarm table entry, and the MOID of the object may be added to this information. Information concerning the identity of the variable which has crossed the threshold may also be added to the alarm owner field of the alarm table entry.

Generation of the TCA notification using the alarm table entry may be carried out in accordance with the RMON Standard RFC 2819. The TCA notification may comprise a time stamp. The TCA notification may comprise one or more variables or variable bindings (varbinds). The varbinds may comprise an alarm index i.e. the index or position of the entry for the variable in the alarm table, an alarm variable i.e. the identity of the variable which has crossed the threshold, an alarm value i.e. the value of the variable that has crossed the threshold, an alarm threshold i.e. the value to which the threshold was set, and an alarm sample type i.e. whether or not the value of the variable is an absolute or delta value. The TCA notification may comprise information identifying whether it is a notification generated when a rising threshold value has been crossed or a notification generated when a falling threshold value has been crossed.

Interrogating the TCA notification may be carried out by a network management system (NMS) of the telecommunications network. This may be carried out using the simple network management protocol (SNMP). Accessing the alarm table entry may be carried out by a network management system (NMS) of the telecommunications network. This may be carried out using the simple network management protocol (SNMP). Reading the MOID of the object from the alarm table entry may be carried out by a network management system (NMS) of the telecommunications network. This may be carried out using the simple network management protocol (SNMP).

The method may further comprise updating the TCA notification to contain the MOID of the object. This may be carried out by a network management system (NMS) of the telecommunications network. The method may further comprise updating the TCA notification to contain the identity of the variable which has crossed the threshold. This may be carried out by a network management system (NMS) of the telecommunications network. The method may further comprise generating a new TCA notification. This may be carried out by a network management system (NMS) of the telecommunications network. The new TCA notification may comprise the information contained in the original TCA notification plus the MOID of the object. The new TCA notification may further comprise the identity of the variable which has crossed the threshold.

The method may further comprise generating an alarm notification using the TCA notification. This may be carried out by a network management system (NMS) of the telecommunications network. The alarm notification may comprise the information contained in the TCA notification, the MOID of the object and information retrieved from a database of the NMS. The alarm notification may comprise information concerning an identity assigned to the alarm notification; a name assigned to the object; the MOID of the object; an identity assigned to the TCA notification; and a code regarding the cause of the threshold crossing. The alarm notification may comprise an active description and active details when the TCA notification is generated when a rising threshold value is crossed, or a clear description and details when the TCA notification is generated when a falling threshold value is crossed. The active and clear details may comprise the varbinds of the TCA notification.

The variable may be associated with a physical or logical peripheral of the NE, for example a connection. The variable may be a counter variable or a gauge variable.

The object of the telecommunications network may comprise a NE, such as a node or a switch, or a component of a NE, such as a board, or a network module (netmod), or an interface, or a port, or a link, or a connection, or a temperature sensor, or a fan bank, or a power supply.

The MOID of an object may comprise a unique identity of the object. The MOID may comprise a data string. This may be a hierarchical data string. The hierarchical data string may start with identification of the NE comprising the object. For example, a MOID for a circuit may comprise identification of the circuit, identification of the board comprising the circuit, and identification of the NE comprising the board.

The NE may comprise one or more management information bases (MIB or MIBS). The NE may comprise a RMON MIB, i.e. a MIB whose structure and content is dictated by the RMON Standard RFC 2819. The RMON MIB may comprise one or more tables, for example the alarm table, an event table and a log table.

The telecommunications network may comprise a NMS. The NMS may comprise software run on a computer system. The telecommunications network may comprise a plurality of NEs, which may be linked to the NMS and may communicate with the NMS via the SNMP using the transmission control protocol over the Internet protocol (TCP/IP). The NMS may perform a plurality of functions. The NMS may manage some or all of the objects in the network. The NMS may create the entry for the variable in the alarm table of the NE. The NMS may create one or more entries for the variable in an event table of the NE. The NMS may construct the MOID of the object. The NMS may store the MOID of the object in the alarm table entry. The NMS may receive the TCA notification. This may be received using the SNMP. This may be received by a fault manager module of the NMS. The fault manager module may add the TCA notification to a database of the NMS. The NMS may interrogate the TCA notification. The NMS may access the alarm table entry. The NMS may read the MOID of the object from the alarm table entry. The NMS may update the TCA notification. The NMS may generate a new TCA notification. The NMS may generate an alarm notification using the TCA notification. The NMS may display the alarm notification, e.g. to a user or a manager of the telecommunications network. The alarm notification may be displayed using a fault graphical user interface (GUI) module of the NMS.

According to a second aspect of the invention, in a telecommunications network in which a threshold crossing alert (TCA) notification is generated when a threshold set for a variable related to an object of a network element (NE) of the network is crossed, there is provided a computer program product for identifying the object, comprising: computer readable program means for creating an entry for the variable in an alarm table of the NE, the entry comprising information concerning the identity of the NE and information concerning the position of the entry in the alarm table, computer readable program means for constructing a managed object identity (MOID) of the object and storing this in the alarm table entry, computer readable program means for generating the TCA notification when the threshold is crossed using the alarm table entry, the TCA notification comprising the information concerning the identity of the NE and the information concerning the position of the entry in the alarm table, computer readable program means for interrogating the TCA notification to read the information concerning the identity of the NE and the information concerning the position of the entry in the alarm table, computer readable program means for accessing the alarm table entry using the information read from the TCA notification, and computer readable program means for identifying the object by reading the MOID of the object from the alarm table entry.

The computer program product may comprise a NMS of the telecommunications network.

According to a third aspect of the invention, there is provided a computer system whose operation is directed by the computer program product of the second aspect of the invention.

According to a fourth aspect of the invention, there is provided a program storage device readable by a machine and encoding a program of instructions for executing the method according to the first aspect of the invention.

An embodiment of the invention will now be described by way of example only, with reference to the accompanying drawing, which is a schematic representation of a telecommunications network in which the method of the first aspect of the invention is carried out.

The drawing shows a telecommunications network which comprises NEs 1, 2 and 3, and a NMS 4. The NEs 1 to 3 each comprise a separate node. The NMS 4 comprises software run on a computer system, and has a fault manager module 5, a fault GUI module 6, and a real time performance monitoring module PMRT 7. The NEs 1 to 3 are linked to each other and to the NMS 4 as shown. The NEs 1 to 3 communicate with each other, and with the NMS, the latter taking place using SNMP over TCP/IP. Each NE 1 to 3 forms an object of the telecommunications network, and comprises various components, e.g. interfaces, which also form objects of the network. There are various variables, for which a threshold can be set, related to each object. For example, the NE 1 may comprise an object in the form of an interface (not shown). A variable related to the interface may comprise the amount of processing capacity of the interface being used, and a threshold comprising a rising threshold value of 90% may be set for this variable.

If a manager of the network wishes to monitor the processing capacity variable of the interface of the NE 1, he uses the real time performance monitoring module PMRT 7 of the NMS 4 to instruct the NE 1 to monitor this variable by creating an entry for the variable in its alarm table. The network manager then uses the NMS 4 to store the following information in the alarm table entry of the NE 1: information concerning the identity of the NE 1; information concerning the position of the entry in the alarm table; information concerning the identity of the variable; information concerning the threshold set for the variable; information concerning one or more events which are executed when the threshold is crossed comprising a pointer to an entry for the variable in an event table of the NE 1; information concerning the identity of the entity (i.e. the network manager) which has created the alarm table entry; information concerning how often the variable should be monitored; and information indicating that the value of the variable is to be monitored. The network manager then uses the NMS 4 to create the entry for the variable in the event table of the NE 1. The event table entry comprises information concerning the events which are executed when the variable crosses the threshold, i.e. generation of a TCA notification and, for example, making an entry in a log table of the NE 1 concerning the threshold crossing. The network manager also uses the NMS 4 to construct the MOID of the interface, and stores the MOID in a table of a database of the NMS 4 (this can be carried out when the NMS 4 first becomes aware of the interface of the NE 1, i.e. prior to the creation of the entry in the alarm table). The network manager then uses the NMS 4 to store the MOID of the interface in the alarm table entry of the NE 1, by copying the MOID from the table of the database of the NMS 4 into an alarm owner field of the alarm table entry. This is a free format text field, and contains information concerning the identity of the entity (the network manager), which has created the alarm table entry. The MOID of the interface is added to the information in this field. Information concerning the identity of the processing capacity variable is also added to the alarm owner field of the alarm table entry.

Subsequently, when the rising threshold value set for the processing capacity variable of the interface is crossed (i.e. exceeded), the alarm table entry for the variable points to the event table entry for the variable and the events detailed therein are executed, i.e. a rising TCA notification is generated. The rising TCA notification comprises the information concerning the identity of the NE 1 and the information concerning the position of the entry in the alarm table, stored in the alarm table entry. The NE 1 sends the rising TCA notification to the NMS 4, using the SNMP, where it is received by the fault manager module S of the NMS. The network manager uses the NMS 4 to interrogate the rising TCA notification to read the information concerning the identity of the NE 1 and the information concerning the position of the entry in the alarm table from the rising TCA notification. The network manager then uses the NMS 4 to access the alarm table entry of the NE 1, and to read the MOID of the interface stored in the alarm table entry. The network manager then uses the NMS 4 to create an alarm notification, which contains the information in the rising TCA notification, the MOID of the interface, and further information retrieved from a database of the NMS 4. The alarm notification is displayed by the fault GUI module 6 of the NMS 4 to the manager of the network. On seeing the alarm notification, the network manager knows that the rising threshold value for the processing capacity has been crossed in the interface of the NE 1, and can take appropriate action.

1-31. (canceled)

32. In a telecommunications network in which a threshold crossing alert (TCA) notification is generated when a threshold set for a variable related to an object of a network element (NE) of the network is crossed, a method of identifying the object, comprising the steps of:
a) creating an entry for the variable in an alarm table of the NE, the entry comprising information concerning an identity of the NE and information concerning a position of the entry in the alarm table;
b) constructing a managed object identity (MOID) of the object and storing the MOID in the alarm table entry;
c) using the alarm table entry to generate the TCA notification when the threshold is crossed, the TCA notification comprising the information concerning the identity of the NE and the information concerning the position of the entry in the alarm table;
d) interrogating the TCA notification to read the information concerning the identity of the NE and the information concerning the position of the entry in the alarm table;
e) accessing the alarm table entry using the information read from the TCA notification; and
f) identifying the object by reading the MOID of the object from the alarm table entry.

33. The method according to claim 32, in which the alarm table entry comprises information concerning an identity of the variable.

34. The method according to claim 32, in which the alarm table entry comprises information concerning the threshold set for the variable.

35. The method according to claim 34, in which the information concerning the threshold comprises a rising threshold value, for which a rising TCA notification is generated if the variable rises above the rising threshold value.

36. The method according to claim 34, in which the information concerning the threshold comprises a falling threshold value, for which a falling TCA notification is generated if the variable falls below the falling threshold value.

37. The method according to claim 32, in which the alarm table entry comprises information concerning at least one event which is executed when the variable crosses the threshold.

38. The method according to claim 37, in which the information concerning the at least one event comprises a pointer to at least one entry for the variable in an event table of the NE, which details the at least one event.

39. The method according to claim 32, further comprising the step of creating at least one entry for the variable in an event table of the NE, the at least one event table entry comprising information concerning at least one event which is executed when the variable crosses the threshold.

40. The method according to claim 39, in which the at least one event includes generating the TCA notification, and also includes making an entry in a log table of the NE concerning the threshold crossing.

41. The method according to claim 32, in which the constructing step is performed by creating the MOID using a network management system (NMS) of the telecommunications network.

42. The method according to claim 41, in which the constructing step is performed by the NMS using information concerning the object and the variable held in the NMS.

43. The method according to claim 32, in which the storing step is performed by copying the MOID from a table of a database of a network management system of the network used to create the MOID.

44. The method according to claim 32, in which the storing step is performed by storing the MOID in an alarm owner field of the alarm table entry.

45. The method according to claim 44, in which the alarm owner field comprises a free format text field, which allows data to be added to existing data in the field.

46. The method according to claim 45, in which the alarm owner field normally comprises information concerning an identity of an entity which has created the alarm table entry, and the MOID of the object is added to this information.

47. The method according to claim 32, in which the TCA notification comprises a time stamp, and at least one of variables and variable bindings.

48. The method according to claim 47, in which the variable bindings comprise an alarm index which indexes a position of the entry for the variable in the alarm table; an alarm variable which identifies the variable which has crossed the threshold; an alarm value of the variable that has crossed the threshold; an alarm threshold which is the value to which the threshold was set; and an alarm sample type which identifies whether the value of the variable is an absolute or delta value.

49. The method according to claim 32, in which the TCA notification comprises information identifying whether it is a notification generated when a rising threshold value has been crossed, or a notification generated when a falling threshold value has been crossed.

50. The method according to claim 32, further comprising the step of generating a new TCA notification.

51. The method according to claim 50, in which the new TCA notification comprises information contained in the first-mentioned TCA notification plus the MOID of the object.

52. The method according to claim 32, further comprising the step of generating an alarm notification using the TCA notification.

53. The method according to claim 52, in which the alarm notification comprises the information contained in the TCA notification, the MOID of the object, and information retrieved from a database of a network management system of the network.

54. The method according to claim 53, in which the alarm notification comprises information concerning an identity assigned to the alarm notification; a name assigned to the object; the MOID of the object; an identity assigned to the TCA notification; a code regarding a cause of the threshold crossing; and an active description and active details when the TCA notification is generated when a rising threshold value is crossed or a clear description and details when the TCA notification is generated when a falling threshold value is crossed.

55. The method according to claim 32, in which the object of the telecommunications network comprises a component of the NE.

56. The method according to claim 32, in which the MOID comprises a hierarchical data string.

57. The method according to claim 32, in which the telecommunications network comprises a network management system (NMS).

58. The method according to claim 57, in which the NMS creates the entry for the variable in the alarm table of the NE, constructs the MOID of the object, stores the MOID of the object in the alarm table entry, interrogates the TCA notification, accesses the alarm table entry, and reads the MOID of the object from the alarm table entry.

59. In a telecommunications network in which a threshold crossing alert (TCA) notification is generated when a threshold set for a variable related to an object of a network element (NE) of the network is crossed, a computer program product for identifying the object, comprising:
a) means for creating an entry for the variable in an alarm table of the NE, the entry comprising information concerning an identity of the NE and information concerning a position of the entry in the alarm table;
b) means for constructing a managed object identity (MOID) of the object and storing the MOID in the alarm table entry;
c) means for generating the TCA notification when the threshold is crossed using the alarm table entry, the TCA notification comprising the information concerning the identity of the NE and the information concerning the position of the entry in the alarm table;
d) means for interrogating the TCA notification to read the information concerning the identity of the NE and the information concerning the position of the entry in the alarm table;
e) means for accessing the alarm table entry using the information read from the TCA notification; and
f) means for identifying the object by reading the MOID of the object from the alarm table entry.
